(19) United States
(12) Patent Application Publication
(10) Pub. No.: US 2026/0154615 A1
(43) Pub. Date: Jun. 4, 2026

(54) MACHINE LEARNING ABSTRACT BEHAVIOR MANAGEMENT

(71) Applicant: Nokia Solutions and Networks Oy, Espoo (FI)

(72) Inventors: Stephen MWANJE, Munich (DE); Haitao TANG, Espoo (FI); Borislava GAJIC, Munich (DE); Shu Qiang SUN, Chengdu (CN)

(21) Appl. No.: 19/122,960

(22) PCT Filed: Oct. 27, 2022
(86) PCT No.: PCT/CN2022/127939

§ 371 Date: Apr. 21, 2025

(51) Int. Cl. G06N 20/00

(52) U.S. Cl. CPC G06N 20/00

(57) ABSTRACT

Embodiments of the present disclosure relate to devices, methods, apparatuses and computer readable storage media ML abstract behavior management. A first device determines a first mapping from network contexts to a set of abstract actions representing actual actions of a machine learning entity, transmits, to a second device, first information indicating the first mapping and receives, from the second device, second information at least associated with a second abstract action corresponding to an actual action of the machine learning entity given an actual network context. The first device also monitors, based on the second information, a difference between a first abstract action determined based on the first mapping and the second abstract action.

### FIELDS

Various example embodiments of the present disclosure generally relate to the field of telecommunication and in particular, to methods, devices, apparatuses and computer readable storage medium for managing machine learning (ML) abstract behavior.

### BACKGROUND

In a typical network operation, an operator configures and operates an ML application (APP) according to the manual of the ML APP (also referred to as MLApp hereafter). Generally, the operator knows configuration management (CM) values used to configure the MLApp, CM values, performance management (PM) values or fault management (FM) values used as input to the MLApp to generate decisions and actions as well as the PM or FM values associated with the actions executed by the MLApp. However, the operator does not usually know the MLApp's internal-decision making details. It is in the interest of the vendor of the MLApp to hide the internal aspects of the implementation of their automation solutions. In addition, even when a vendor is willing to expose those internal characteristics and aspects, the internal aspects constitute too much detail that is unnecessary information for the operator.

Nevertheless, even without the internal details of the solutions, the operator needs to operate the system together with the automation solutions. Specifically, the operator needs to guide the solution of the MLApp and to configure it to achieve the desired outcomes. In some cases, the MLApp has specific actions which it may take, while the operator also has operational actions which it needs to take to steer a solution, e.g. to switch off the solution, to reconfigure the solution, and to change the solutions input. There is a need to match the operator's actions with operational modes or contexts of automation solutions.

### SUMMARY

In a first aspect of the present disclosure, there is provided a first device. The first device comprises at least one processor; and at least one memory storing instructions that, when executed by the at least one processor, cause the first device at least to perform: determining a first mapping from network contexts to a set of abstract actions representing actual actions of a machine learning entity; transmitting, to a second device, first information indicating the first mapping; receiving, from the second device, second information at least associated with a second abstract action corresponding to an actual action of the machine learning entity given an actual network context; and monitoring, based on the second information, a difference between a first abstract action determined based on the first mapping and the second abstract action.

In a second aspect of the present disclosure, there is provided a second device. The second device comprises at least one processor; and at least one memory storing instructions that, when executed by the at least one processor, cause the second device at least to perform: receiving, from a first device, first information indicating a first mapping from network contexts to a set of abstract actions representing actual actions of a machine learning entity; determining a first abstract action based on the first mapping and an actual network context used by the machine learning entity; determining a second abstract action corresponding to an actual action of the machine learning entity given the actual network context based on a second mapping from the actual actions of the machine learning entity to the set of abstract actions; and monitoring a difference between the first and second abstract actions; and transmitting, to the first device, second information at least associated with the second abstract action.

In a third aspect of the present disclosure, there is provided a third device. The third device comprises at least one processor; and at least one memory storing instructions that, when executed by the at least one processor, cause the third device at least to perform: receiving, from a first device, a first registration request to store a first mapping from network contexts to a set of abstract actions representing actual actions of a machine learning entity; and storing the first mapping in association with an identification of the machine learning entity.

In a fourth aspect of the present disclosure, there is provided a fourth device. The fourth device comprises at least one processor; and at least one memory storing instructions that, when executed by the at least one processor, cause the fourth device at least to perform: receiving, from a first device, a first message to initiate training of the machine learning entity based on an updated first mapping from network contexts to a set of abstract actions representing actual actions of a machine learning entity; determining whether the training of the machine learning entity is completed; and in accordance with a determination that the training is completed, transmitting, to the first device, a second message indicating a trained instance of the machine learning entity.

In a fifth aspect of the present disclosure, there is provided a method. The method comprises: at a first device, determining a first mapping from network contexts to a set of abstract actions representing actual actions of a machine learning entity; transmitting, to a second device, first information indicating the first mapping; receiving, from the second device, second information at least associated with a second abstract action corresponding to an actual action of the machine learning entity given an actual network context; and monitoring, based on the second information, a difference between a first abstract action determined based on the first mapping and the second abstract action.

In a sixth aspect of the present disclosure, there is provided a method. The method comprises: at a second device, receiving, from a first device, first information indicating a first mapping from network contexts to a set of abstract actions representing actual actions of a machine learning entity; determining a first abstract action based on the first mapping and an actual network context used by the machine learning entity; determining a second abstract action corresponding to an actual action of the machine learning entity given the actual network context based on a second mapping from the actual actions of the machine learning entity to the set of abstract actions; and monitoring a difference between the first and second abstract actions; and transmitting, to the first device, second information at least associated with the second abstract action.

In a seventh aspect of the present disclosure, there is provided a method. The method comprises: at a third device, receiving, from a first device, a first registration request to store a first mapping from network contexts to a set of abstract actions representing actual actions of a machine learning entity; and storing the first mapping in association with an identification of the machine learning entity.

In an eighth aspect of the present disclosure, there is provided a method. The method comprises: at a fourth device, receiving, from a first device, a first message to initiate training of the machine learning entity based on an updated first mapping from network contexts to a set of abstract actions representing actual actions of a machine learning entity; determining whether the training of the machine learning entity is completed; and in accordance with a determination that the training is completed, transmitting, to the first device, a second message indicating a trained instance of the machine learning entity.

In a ninth aspect of the present disclosure, there is provided a first apparatus. The first apparatus comprises means for determining a first mapping from network contexts to a set of abstract actions representing actual actions of a machine learning entity; means for transmitting, to a second device, first information indicating the first mapping; means for receiving, from the second device, second information at least associated with a second abstract action corresponding to an actual action of the machine learning entity given an actual network context; and means for monitoring, based on the second information, a difference between a first abstract action determined based on the first mapping and the second abstract action.

In a tenth aspect of the present disclosure, there is provided a second apparatus. The second apparatus comprises means for receiving, from a first device, first information indicating a first mapping from network contexts to a set of abstract actions representing actual actions of a machine learning entity; means for determining a first abstract action based on the first mapping and an actual network context used by the machine learning entity; means for determining a second abstract action corresponding to an actual action of the machine learning entity given the actual network context based on a second mapping from the actual actions of the machine learning entity to the set of abstract actions; and means for monitoring a difference between the first and second abstract actions; and means for transmitting, to the first device, second information at least associated with the second abstract action.

In an eleventh aspect of the present disclosure, there is provided a third apparatus. The third apparatus comprises means for receiving, from a first device, a first registration request to store a first mapping from network contexts to a set of abstract actions representing actual actions of a machine learning entity; and means for storing the first mapping in association with an identification of the machine learning entity.

In a twelfth aspect of the present disclosure, there is provided a fourth apparatus. The fourth apparatus comprises means for receiving, from a first device, a first message to initiate training of the machine learning entity based on an updated first mapping from network contexts to a set of abstract actions representing actual actions of a machine learning entity; means for determining whether the training of the machine learning entity is completed; and means for in accordance with a determination that the training is completed, transmitting, to the first device, a second message indicating a trained instance of the machine learning entity.

In a thirteenth aspect of the present disclosure, there is provided a computer readable medium. The computer readable medium comprises instructions stored thereon for causing an apparatus to perform at least the method according to the fifth aspect.

In a fourteenth aspect of the present disclosure, there is provided a computer readable medium. The computer readable medium comprises instructions stored thereon for causing an apparatus to perform at least the method according to the sixth aspect.

In a fifteenth aspect of the present disclosure, there is provided a computer readable medium. The computer readable medium comprises instructions stored thereon for causing an apparatus to perform at least the method according to the seventh aspect.

In a sixteenth aspect of the present disclosure, there is provided a computer readable medium. The computer readable medium comprises instructions stored thereon for causing an apparatus to perform at least the method according to the eighth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example signaling diagram of a ML abstract behavior management procedure according to some example embodiments of the present disclosure;

FIG. 3 illustrates a further example signaling diagram of a ML abstract behavior management procedure according to some example embodiments of the present disclosure;

FIG. 4 illustrates a still further example signaling diagram of a ML abstract behavior management procedure according to some example embodiments of the present disclosure;

FIG. 5 illustrates yet another example signaling diagram of a retraining procedure according to some example embodiments of the present disclosure;

FIG. 6A illustrates an example diagram of an information model for abstract behavior when exhibited by the artificial intelligence (AI)/ML function according to some example embodiments of the present disclosure;

FIG. 6B illustrates an example diagram of an information model for abstract behavior when exhibited by the ML Entity according to some example embodiments of the present disclosure;

FIG. 6C illustrates an example diagram of inheritance relations for abstract behavior according to some example embodiments of the present disclosure;

FIG. 7 illustrates a flowchart of a method implemented at a first device according to some example embodiments of the present disclosure;

FIG. 8 illustrates a flowchart of a method implemented at a second device according to some example embodiments of the present disclosure;

FIG. 9 illustrates a flowchart of a method implemented at a third device according to some example embodiments of the present disclosure;

FIG. 10 illustrates a flowchart of a method implemented at a fourth device according to some example embodiments of the present disclosure;

FIG. 11 illustrates a simplified block diagram of a device that is suitable for implementing example embodiments of the present disclosure; and

FIG. 12 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

As used herein, the term “training of an ML entity” or “retraining of an ML entity” may refer to the training or retaining of an ML model of the ML entity or associated with the ML entity.

As briefly mentioned above, the operator needs to operate the system together with the automation solution of the MLApp. Specifically, the operator needs to guide the solution and to configure it to achieve the desired outcomes. For example, Table 1 shows three automation use cases, that is, the fire evacuation MLApp that decides how users should be evaluated from a building, an autonomous driving use case (also called as “Robocar”) with an MLApp that decides how to autonomously drive to given location, and the load balancing (AutoLB) MLApp that decides how to distribute load among networking objects. In all these cases, the MLApp has specific actions which it may take, while the operator also has operational actions which it needs to take to steer the solution, e.g. to switch off the solution, to reconfigure the solution, and to change the solution input.

TABLE 1
Operability of Automation Solutions

| | | | Example | |
|---|---|---|---|---|
| Automation | | MLApp's | MLApp's | Operator's |
| use case | Description | context | decisions | Actions |
| Fire | Given a location | Person's | The direction | State direction |
| evacuation | of a fire, the | location | needed to run | of exit, |
| | MLApp generates | Number and | from a fire | e.g. request |
| | optimal paths to | locations | and exit a | for path to |
| | evacuate people | of exits | building | the west - |
| | in different parts | Building | open gates, | fire in the |
| | of a building | layout | open sprinklers | east |
| | | Compound | | |
| | | layout | | |
| Autonomous | MLApp that | Impediments | self-driving, | change |
| driving/ | decides how to | on the road | chose roads, | destination, |
| robotic | autonomously | Congestion | navigate on | stop the |
| car (Robocar) | drive to | on the route | the road, . . . | car, . . . |
| | given location | | | |
| load | Distribute load | Values of | select handover/ | set the |
| balancing | among different | relevant PM, | cell selection | threshold |
| (AutoLB) | networking | Cell relations | values | values, |
| | objects, e.g., | | | deactivate |
| | among cells | | | AutoLB |
| | of a cellular | | | |
| | network. | | | |

Network automation functions (as is also the case for other automation functions) do not typically expose the detailed knowledge of the internal behavior of the automation function. However, operational/operability actions that need to be taken by the operator are (or at least need to be) associated with the internal actions and context considered in the decisions of the automation function.

Taking the fire evacuation use case for example, the operator's decision to request for a plan to exit towards the west is associated with the knowledge whether there is a gate existing on the west/its nearby, or not. In this case, it is assumed that there is no western gate and that the solution does not consider other available gates. If the operator request for exit to the west, the solution may send people towards a wall because it has only considered the building layout without considering the exits. On the other hand, if the operator knows that the solution does not consider available exits, and the operator knows there is a north-west exit the operator may instead request for paths towards the north, there is a higher chance that people will be sent to a direction where they may easily exit the building.

It would be good to expose the internal contexts to the operator so the operator may set the appropriate decisions. However, revealing the relation at this level would show the commercial secrete of the MLApp. For example, for an MLApp with model-free Q-learning, the relations are the learned state-action policies internal to the MLApp.

Accordingly, it is necessary to relate the operator's actions to the internal albeit abstract context considered by the automation solution. The automation solution may find the best possible paths to exit the building or may request the operator to reconsider its operation action if the operation action would lead to a dead end otherwise. In order for an operator to be able to use the ML model or solution in appropriate way, some minimal level of information regarding the model/solution functionality needs to be provided by the vendor. Such way of model/solution sharing between different parties (between different vendors, between vendors and operators, etc.) is often seen as an approach in solving different use cases, e.g., mobility optimization where model/solution may be shared between gNB and UEs. It is of fundamental importance to have the means where such sharing is possible without disclosing the proprietary internals of the model provider but enabling the model/solution consumer to utilize the model/solution in adequate way and/or to control/steer its behavior in preferred direction.

However, without the knowledge of the model/solution details, it may be difficult for the operator to understand the overall behavior of the MLApp. At the same time, if a part of the MLApp's decisions/actions are not what preferred by the operator, the operator may do not know how to instruct the MLApp to behave accordingly. Solutions need to be figured out to enable the operator to associate the operation actions to the AI/ML context of the MLApp, as well as guide the AI/ML-enabled function or the automation solution.

To solve the above and other potential issues, example embodiments of the present disclosure propose a solution for enabling the AI/ML management service (MnS) consumers to utilize the MLApp in way that they may control the behavior of the MLApp in a preferred direction without knowing the internal details of the MLApp.

Example embodiments of the present disclosure will be described in detail below with reference to the accompanying drawings.

### Example Environment and Work Principle

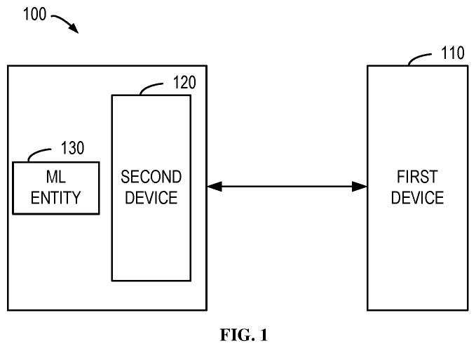

FIG. 1 illustrates an example communication environment 100 in which example embodiments of the present disclosure may be implemented. In the communication environment 100, there are a first device 110, a second device 120 and a ML entity 130.

The first device 110 may be a management service (MnS) consumer, for example, an AI/ML MnS Consumer. In some example embodiments, the AI/ML MnS Consumer may be a function of Operation Administration and Maintenance (OAM) or a network function (NF).

The second device 120 may be a MnS producer, for example, an AI/ML MnS Producer. In some example embodiments, the AI/ML MnS Consumer may be a gNB/CU, another NF different from the first device 110, or an OAM function, where the ML entity (for example, the MLApp) executes.

The ML entity 130 is associated with the second device 120. The ML entity 130 may be an ML model or may contain an ML model and ML model related metadata. The ML entity 130 may be managed as a single composite entity. In some example embodiments, the ML entity 130 may be implemented as a MLApp. It is to be understood that this is just for purpose of illustration, without suggesting any limitation to embodiments of the present disclosure.

According to example embodiments of the present disclosure, solutions are proposed for the trusted operation of the ML entity 130 based on AI/ML context abstraction. In some example embodiments, the first device 110 may be the operator or a management function (MnF) of the operator, and may be implemented as, for example, the AI/ML MnS Consumer. The second device 120 may provide the management service as the producer of management services based on the ML entity 130, which is herein called as the AI/ML management service producer or AI/ML MnS Producer.

The second device 120 may inform the first device 110 (e.g. the operator) about the abstract behavior of the ML entity 130, in an ML entity agnostic manner without the need to expose its internal characteristics of the ML entity 130 or AI/ML Function. The abstract behavior of the ML entity 130 may comprise an abstract state representing an actual state associated with the ML entity 130 and an abstract action representing an actual action of the ML entity 130.

The second device 120 may enable the first device 110, for example, an authorized AI/ML MnS consumer (e.g. the operator), to configure the behavior of the ML entity 130, in an ML entity agnostic manner that does need to expose its internal characteristics. It enables the first device 110, which is a management service consumer of the ML entity 130, to configure, manage, or steer the operation of the ML entity 130 through a set of abstract states and abstract actions. The ML entity 130 may then make its action or decision according to the operation by this management service consumer.

In some example embodiments, the second device 120 may have a set of candidate abstract states which may be notified to the first device 110. The first device 110 may configure the abstract behavior by selecting the actions to be taken in any one abstract state.

The contexts and states/actions of the second device 120 may be grouped into operational modes represented by abstract states that are understood by both the first device 110 and the second device 120.

For example, the Robocar may be considered to have a few (e.g., two) abstract states, namely, a normal-operations state and an extraneous-circumstances state. In the normal-operations state, the Robocar may be simply given a destination and let to act as it wishes. In the extraneous-circumstances state which represents unusual conditions such an accident on the road ahead (as learned from the radio), abnormal street conditions such as an unusually wet street due to pipe splashing water onto the street or a street power line bent into the road. In such cases the operator actions may be different, e.g., to ask the car to make a sudden stop or sudden turn.

Similarly for a reinforcement learning (RL) solution on load balancing, the different RL state-action pairs may be mapped to different operational modes which then become the abstract states of the automation solution.

The abstract states may need to be agreed between the second device 120 (represented by the vendor of the solution) and the first device 110 for example the operator of the solution. For example, the abstract states may be to a standardized set of abstract states agreed among multiple potential developers and operators.

The expected number of abstract states may depend on the use case but is in general a small number. The expected number may be standardized to a small value but large enough to support most use cases (e.g., a set of states numbered 0-15 or 0-63).

The candidate set of abstract states and the possible actions in any such state may be set by the second device 120 and may be notified to the first device 110. The notification of abstract states may also include the features that define the respective abstract states.

The second device 120 may allow the first device 110 to specify, from the candidate set of abstract states, a subset of abstract states for the ML entity 130 that may be applied to provide the management services. The operator or the first device 110 may decide how to derive the subset of abstract states from the features and feature values that define the abstract states.

The first device 110 may define a set of abstract actions to be mapped to the abstract states that are also defined by the first device 110. The use case may require fewer states than the standardized set, i.e., the first device 110 may set a smaller number of abstract states than the number that has been standardized. In that case, only the required states are mapped while the unmapped states may take a default action, like “NoAction.”

The second device 120 may have a mapping function that maps between the internal context and actions of the second device 120 and the set of abstract actions defined by first device 110.

The mapping function may be a defined set of rules or an ML mapping function to be trained by the second device 120 (or its supporting functions) to learn the mapping between the second device 120's internal context and states/actions to the first device 110's defined set of abstract actions. The first device 110 may configure the specific abstract state IDs to specific abstract actions itself. Such configuration is then passed to the second device 120.

It is to be understood that the actual operation may require more states than those set by the operator. For example of the Robocar use case, in order to limit the number of abstract states, the first device 110 may define a single abstract state called “extraneous-circumstances” which in fact aggregates multiple small internal states within the second device 120.

In any case, the second device 120 maps its input context to the first device 110 seen abstract action through the above first device 110's given mapping functions. The second device 120 takes internal actions for its input context. The second device 120 also maps the internal action into its seen abstract action through its internal mapping function and compare if both the mapped abstract actions are the same.

The first device 110 may observe the second device 120's overall behaviors by monitoring the abstract actions exhibited by the second device 120 during operation. If retraining of the ML entity 130 is needed (triggered by the second device 120, first device 110, or other entity), the ML entity 130 may be retrained at one of OAM/network entities as configured by the operator.

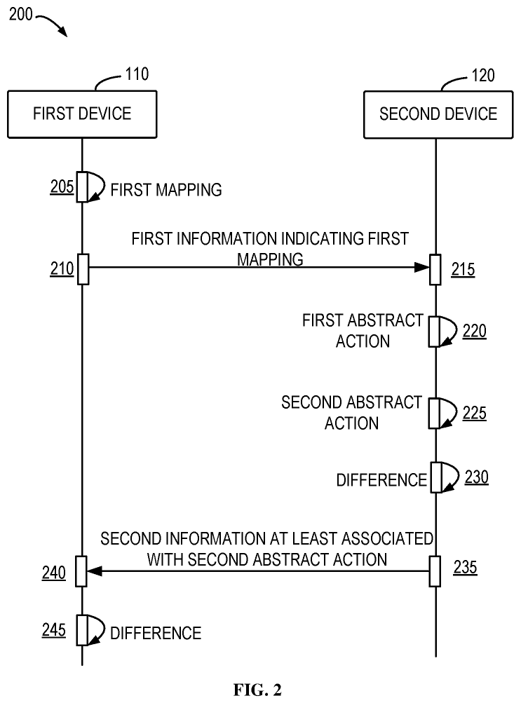

A general procedure is described above with reference to FIG. 1. To better understand the ML abstract behavior management of the present disclosure. Some example embodiments are described below with reference to FIG. 2 to FIG. 5.

In the following, for the purpose of illustration, some example embodiments are described with the first device 110 operating as a MnS consumer, the second device 120 operating as a MnS producer, and the ML entity 130 being implemented as an MLApp. However, in some example embodiments, operations described in connection with the first device 110 may be implemented at a device other than the MnS consumer, and operations described in connection with the second device 120 may be implemented at a device other than the MnS producer.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Example General Procedure for ML Abstract Behavior Management

FIG. 2 illustrates an example signaling diagram of a ML abstract behavior management procedure 200 according to some example embodiments of the present disclosure. For the purposes of discussion, the procedure 200 will be discussed with reference to FIG. 1, for example, by using the first device 110 and the second device 120.

As shown in the management procedure 200, the first device 110 determines (205) a first mapping from network contexts to a set of abstract actions representing actual actions of the ML entity 130, and transmits (210) first information indicating the first mapping to the second device 120. The network contexts may include any suitable attribute of the communication network. For example, the network contexts may include the CM, PM, FM values. For another example, the network contexts may include other types of management data, such as Trace.

In some example embodiments, the first mapping determined by the first device 110 may comprise two portions. The first portion (also referred to as “third mapping” hereafter) maps the network contexts to a first set of abstract states. The second portion (also referred to as “fourth mapping” hereafter) maps the first set of abstract states to the set of abstract actions. As an example, the third mapping may be implemented as an input state abstraction function which maps the CM/PM/FM attributes of the ML entity 130 input to abstract states, which is defined by the first device 110 per ML entity. The fourth mapping may be implemented as a control action abstraction function for mapping abstract states to abstract actions. This control action abstraction function may be defined by the first device 110 per ML entity as well.

In some example embodiments, the first set of abstract states may be a subset of a second set of abstract states. In other words, the second set of abstract states may be the set of candidate abstract states as mentioned with reference to FIG. 1. The first device 110 specifies or selects, from the set of candidate abstract states, the first set of abstract states to be applied. In the following, an abstract state in the first set may be also referred to as an applied abstract state and an abstract state in the second set may be also referred to as a candidate abstract state. It is to be understood that the operator and vendor of the ML model of the ML entity 130 may agree on the abstract state space and abstract actions for the ML model.

In some example embodiments, an abstract behavior may be associated with the ML entity 130, or a function associated with the ML entity 130. The abstract behavior may comprise one or more abstract states and corresponding abstract actions. An abstract state in the second set, or in other words, a candidate abstract state may be associated with an identifier of this abstract state, a description of the abstract state, at least one abstract action available in the abstract state, and/or the like.

As an example, in order to implement AI/ML abstract behavior, an MLEntity or AI/MLFunction may have an object which is called abstract behavior that comprises characteristics of the abstract behavior of the MLEntity or AI/MLFunction. The abstract behavior comprises two lists, a list of candidate abstract states and their candidate actions and a list of the selected and configured abstract states and their respective selected actions.

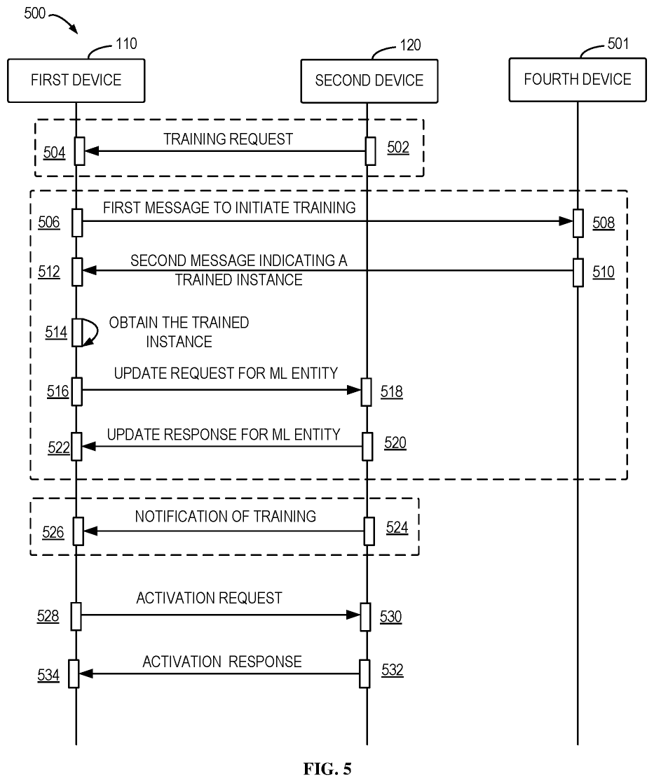

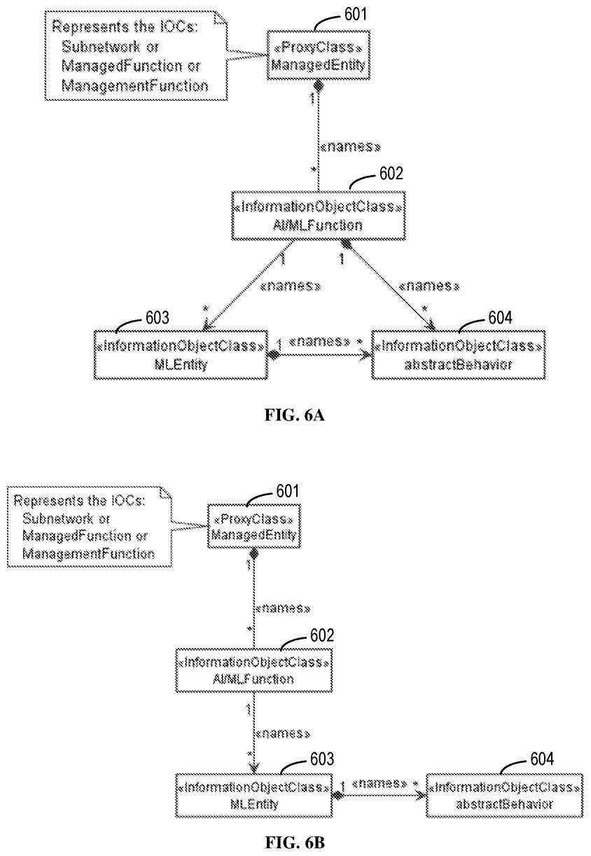

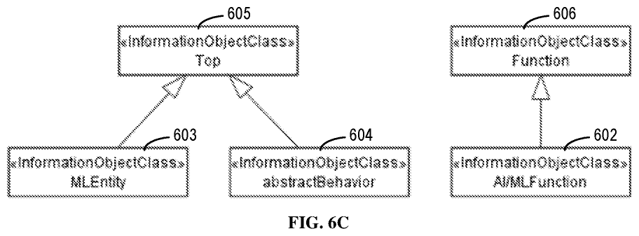

To this end, an information object class (IOC) or datatype for the abstract behavior, which is called “abstractBehavior”, may be introduced. In some example embodiments, the IOC may be name contained in an MLEntity or an AI/MLFunction, as will be described with reference to FIG. 6A. The abstractBehavior may have 2 attributes, that is, the “candidateAbstractStates” and the “applied AbstractStates”.

The candidate AbstractState is a list of abstract states and where each state has a list of candidate abstract actions for that abstract state. Accordingly, a datatype for the candidate abstract state, which is called “candidateAbstractState”, may be introduced. Each state in the candidateAbstractState may have an identifier, a human readable description and a list of possible actions that may be selected for that abstract state. As such, the candidateAbstractState may have an attribute for possible actions, which is called “possibleActions” that holds the possible actions for that state. The possibleActions attribute may be an enumeration of the actions from which the Mns consumer may chose those to be applied. The appliedAbstractStates is a list of state-action tuples. Each state may be represented by an identifier for the respective state as listed in the candidate AbstractBehavior. Similarly, each action may be represented by an identifier for the respective action as listed in the candidate AbstractBehavior.

Continuing with the procedure 200, the second device 120 receives (215) the first information from the first device 110. The second device 120 determines (220) a first abstract action based on the first mapping and an actual network context used by the ML entity 130. For example, the ML entity 130 may perform an actual action by using a given actual network context as an input to an ML model. Then, the second device 120 may map the given actual network context to the first abstract action according to the first mapping. The first abstract action may be considered as the operator-seen abstract action.

The second device 120 also determines (225) a second abstract action corresponding to an actual action of the ML entity 130 given the actual network context based on a second mapping from the actual actions of the ML entity 130 to the set of abstract actions. The second mapping is an internal mapping of the second device 120 and is not known by the first device 110. The second mapping may be defined by the vendor of the ML model. For the example mentioned above, the second device 120 may map the actual action to the second abstract state according to the second mapping. The second abstract action may be considered as the ML entity-seen abstract action, for example, the MLApp-seen abstract action.

Then, the second device 120 monitors (230) a difference between the first and second abstract actions. For example, the second device 120 may compare the first and second abstract actions to determine whether there is any conflict between the first and second abstract actions.

The second device 120 transmits (235), to the first device 110, second information at least associated with the second abstract action. The first device 110 receives (240) the second information from the second device 120. Accordingly, the first device 110 monitors (245), based on the second information, a difference between a first abstract actions determined based on the first mapping and the second abstract action.

The second information may comprise any suitable type of information from which the first device 110 can determine the difference. In some example embodiments, the second information may include an indication of the second abstract action. Accordingly, the first device 110 may determine the first abstract action at its own side according to the first mapping. The first device 110 then may compare the first and second abstract actions and monitor the difference.

Alternatively, or in addition, in some example embodiments, the second information may include indications of the first and second abstract actions. Accordingly, the first device 110 may compare the first and second abstract actions and monitor the difference. Alternatively, or in addition, in some example embodiments, the second information may include an indication of whether the difference between the first and second abstract actions exists. Accordingly, the first device 110 may monitor the difference directly based on the indication.

A general procedure 200 is described above. More details of example use cases are now discussed in the following example embodiments of the present disclosure. In these example embodiments, for purpose of illustration, the first device 110 may be referred to as, for example, the operator, the MnS Consumer, the AI/ML MnS Consumer, and the like, and the second device 120 may be referred to as, for example, the vendor, the MnF producer, the AI/ML MnS producer, and the like. As for the ML entity 130, it may be also referred to as MLApp. It is to be understood that this is just for purpose of discussion, rather than suggesting any limitations.

In some example embodiments, relevant abstract states and abstract actions may be standardized or defined by the first device 110 (for example, the operator) but known to the second device 120 (for example, the MLApp vendor). The first device 110 and the second device 120 may thus understand each other when interacting with the abstract states and abstract actions. The semantics of the abstract states and abstract actions are usually use case or MLApp specific (for example, the Self-Organizing Network functions), while they all share the same principle. Therefore, it may be enough that two sets of IDs are standardized to identify any number limited abstract states and abstract actions. For example, Table 2 presents the abstract states and the corresponding abstract actions of an MLApp for a mobility load balancing use case. Here, an abstract action may be associated to a real action of handover trigger update, etc., and needed to be known to both the first device 110 and the second device 120.

TABLE 2

| Abstract | Abstract | Abstract |
|---|---|---|
| State ID | Action ID | Action |
| StateID | ActionID | letEasierIn* |
| | | letEasierOut* |
| | | noAction* |
| 0 | 0 | noAction |
| 1 | 1 | letEasierIn |
| 2 | 1 | letEasierIn |
| 3 | 2 | letEasierOut |

Similarly for further use cases (e.g., handover optimization), the sets of abstract states and actions may be provided in Table 3. Table 3 shows example abstract states and actions of an MLApp for handover optimization use case, where the complete table needs to be known to both the second device 120 and the first device 110.

TABLE 3

| Abstract | Abstract | Abstract |
|---|---|---|
| State ID | Action ID | Action |
| StateID | Actinoids | noAction* |
| | | scaleOut/UpVirtualResources |
| | | (x% of memory/y% of CPU) |
| | | RescheduleRadioResources* |
| . . . | . . . | . . . |

It is to be understood that “*” in Table 2 and Table 3 indicates that the first device 110 and the second device 120 have the same understanding of the abstract actions defined by the first device 110. The first device 110 may further define the max step value that an abstract action may take.

As can be seen from the above description, the trusted MLApp operation is based on the relevant abstract states and abstract actions co-defined by the first device 110 and the second device 120 or standardized for the MLApp. In some example embodiments, three mapping functions may be used, i.e., input state abstraction function which maps from actual network context (the input of the ML model) to an abstract state, control action abstraction function which maps from an abstract state to an abstract action, and MLApp action abstraction function which maps from an actual action/decision of the MLApp to the MLApp seen abstract action.

The first device 110 controls the MLApp's actual decision/action indirectly by providing the input state abstraction function and control action abstraction function to the second device 120. The second device 120 receives these two mapping functions from the first device 110. These two mapping functions map from the APP-relevant actual CM/PM/FM (including also other types of management data, e.g., Trace, using CM/PM/FM as example) and/or other context values to operator seen abstract states and abstract actions. The MLApp action abstraction function is not known to the first device 110, and maps an MLApp-produced CM/decision value to an MLApp-seen abstract action and, if requested, presents the MLApp seen abstract action to the first device 110.

The first device 110 may observe the MLApp's overall behaviors by monitoring the MLApp-seen abstract actions exhibited by the MLApp during operation. That is, the overall behavior of the MLApp is effectively shown with all the abstract actions exhibited by the MLApp. Given certain actual network context input (for example, the actual CM/PM/FM, etc.) to the MLApp, if the corresponding abstract action exhibited by the MLApp is different from the abstract action mapped from the same input with the input state abstraction function and control action abstraction function, the MLApp's action/decision conflicts with the corresponding abstract action given by the first device 110. The MLApp may be retrained to align with the operator-configured corresponding abstract action when needed.

There may be any suitable mapping function. In some example embodiments, as mentioned above, the input state abstraction function, the control action abstraction function, and the MLApp action abstraction function may be used. In the following, the input state abstraction function and the control action abstraction function may be collectively referred to as abstraction mappings.

The input state abstraction function (also denoted as F_{actual2as}), which is discussed above as the third mapping, may map the CM/PM/FM attributes (including also other types of management data, e.g., Trace, using CM/PM/FM as example and/or other context values) of the MLApp input into the abstract states, which is defined by the operator per MLApp. This F_{actual2as} may be an ML function itself that may learn the “optimal” mapping itself. For example, it could learn based on vendor's given data initially and, when in service, it learns based on operator given data. The following expression (1) illustrates an example mapping of the F_{actual2as}:

$${F}_{actual 2 as} : {}^{1 … *} ( CM / PM / FM parameter : value range ) \to abstractStateID . \qquad ( 1 )$$

Control action abstraction function (also denoted as Fₐₛ₂ₐₐ), which is discussed above as the fourth mapping, maps abstract states to abstract actions. This control action abstraction function may be defined by the operator per MLApp (i.e., simply the extraction by the operator from the use case specific table of abstract state and abstract action, e.g., Table 2 or Table 3). The following expression (2) illustrates an example mapping of the Fₐₛ₂ₐₐ:

$${F}_{as 2 aa} : abstractStateID \to abstractAction ( {}^{*} ( parameter : value ) ) . \qquad ( 2 )$$

MLApp action abstraction function (also denoted as Fᵣₐ₂ₐₐ) maps between the MLApp-decided real actions (MLApp's actual CM/decision values) and the MLApp-determined/seen abstract actions. It is MLApp specific and is initially defined by the MLApp vendor, while the MLApp itself may retrain this mapping function internally, following the update of the F_{actual2as} and Fₐₛ₂ₐₐ by the operator during MLApp operation.

After the vendor gets the operator defined/approved set of abstract actions for the MLApp, the vendor of the MLApp may define this function to map from the MLApp's real action to an abstract action as the following:

$${F}_{ra 2 aa} : realAction ( {}^{*} ( CM / decision parameter : value ) ) \to abstractAction ( {}^{*} ( parameter : value ) ) \qquad ( 3 )$$

where Fᵣₐ₂ₐₐ is known only to the second device 120 and would be kept away from the access of the first device 110. Further, such a real action is decided according to an internal state known only to the second device 120. The abstract action “abstractAction (*(parameter: value))” is known to both the first device 110 and the second device 120.

The vendor may then provide the defined Fᵣₐ₂ₐₐ to the second device 120 and this Fᵣₐ₂ₐₐ becomes an integral part of the second device 120.

By this way, the second device 120 knows how to map from the real input values to the abstract state and the abstract action based on the two mappings F_{actual2as} and Fₐₛ₂ₐₐ. In addition, the second device 120 knows how to map the real action into its seen abstract action based on the internal mapping Fᵣₐ₂ₐₐ. This MLApp is then ready for the operator to operate. The MLApp decides its real action/decision only based on the real input values to the MLApp.

Sometimes, the second device 120 may find that the abstract action mapped based on F_{actual2as} and Fₐₛ₂ₐₐ is different from MLApp-seen abstract action mapped based on the mapping function Fᵣₐ₂ₐₐ. This case may be caused by operator's update of an abstract action of the mapping Fₐₛ₂ₐₐ provided to the second device 120. The difference indicates a conflict between MLApp's real action and the operator provided abstract action, corresponding to the actual input values to the APP. In this case, the MLApp may act according to the operator's given policy for such a conflict. For example, the MLApp may abandon the conflicting real action or take an alternative and non-conflicting real action instead. The second device 120 may report the conflict or the statistics on the conflicts (in a period/scope) to the first device 110. The second device 120 or the first device 110 may request to retrain the MLApp according to the operator updated Fₐₛ₂ₐₐ. The mapping function Fᵣₐ₂ₐₐ may be updated during the MLApp's retraining. Retraining will be described below with reference to FIG. 5.

With example embodiments of the present disclosure, the vendor can let the MLApp (e.g., RL-based APP) to show the behavior and to allow the operator's control of its behavior on an abstraction level, while not showing the operator any detailed states and internal design of the APP. In this way, not only the MLApp is controllable by the operator but also the vendor's intellectual property and commercial interests of its MLApp can be protected from the operator.

Simplification is another main advantage. With example embodiments of the present disclosure, the operator can set constraints in a simplified way, can test compliance and/or enforce them. The operator can also test for conditions it finds to be important or essential so that it can get insights how the MLApp is handling these and thus builds the trust/confidence on the MLApp.

The MLApp could also measure the statistics of conflict cases in a given network scope along the time since the state-action pair is updated. The criteria to retrain the MLApp would be set as, for example, more than 5% of decisions conflicting with the abstract actions set by operator for the MLApp.

### Example Initialization Procedure for ML Abstract Behavior Management

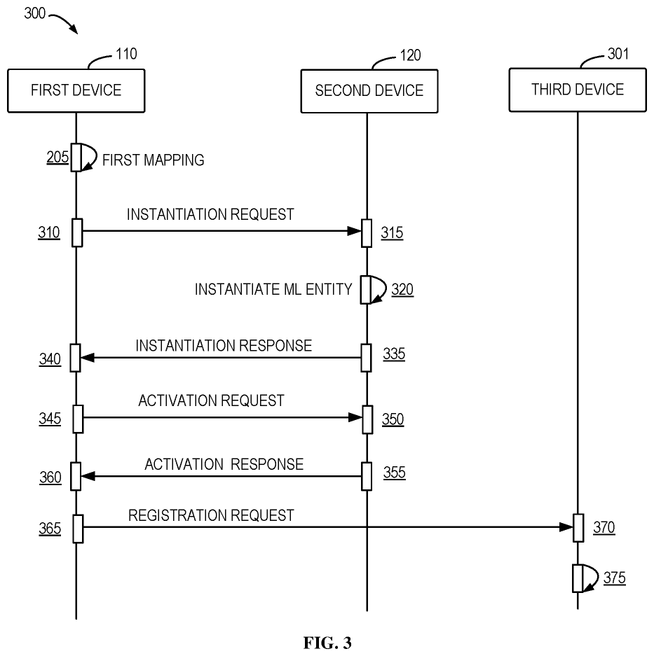

FIG. 3 illustrates a further example signaling diagram of a ML abstract behavior management procedure 300 according to some example embodiments of the present disclosure. For the purposes of discussion, the procedure 300 will be discussed with reference to the first device 110 and the second device 120 of FIG. 1, as well as a third device 301 which may be, for example, a repository. In some example embodiments, the third device 301 may be implemented as a repository function at a core network or a function at OAM to register the profile/metadata of the ML entity instance. For example, the procedure 300 may be a procedure to install and active an MLApp instance (such as, MLApp1) together with the mappings mentioned above.

In the example procedure 300, the first device 110 determines (205) a first mapping from network contexts to a set of abstract actions representing actual actions of a ML entity 130, as the same as described with reference to FIG. 2. For example, the first device 110 may receive a request to install the MLApp1. In response to the request, the first device 110 may generate the mapping instances for F_{actual2as} and Fₐₛ₂ₐₐ per MLApp1 and the network context.

The first device 110 may transmit (310) to the second device 120 an instantiation request to instantiate the ML entity 130 with the first mapping. The instantiation request comprises the first information indicating the first mapping. For example, the instantiation request may be a provisioning management service (ProvMnS) request to install the MLApp1. The ProvMnS request may include an APP-ID of the MLApp1 as well as F_{actual2as} and Fₐₛ₂ₐₐ.

The second device 120 may receive (315) the instantiation request from the first device 110. In response to the instantiation request, the second device 120 may instantiate (320) the ML entity 130 with the first mapping. For example, in response to the ProvMnS request, the second device 120 may install the MLApp1 with F_{actual2as} and Fₐₛ₂ₐₐ.

Then, the second device 120 may transmit (335) an instantiation response indicating completion of the instantiation of the ML entity 130. The first device 110 may receive (340) the instantiation response from the second device 120. For example, the instantiation response may be a ProvMnS response indicating the installation of the MLApp1, which may include the APP-ID of the MLApp1.

In some example embodiments, the first device 110 may transmit (345) an activation request to the second device 120 to activate the ML entity 130. The second device 120, upon receipt (350) of the activation request, may transmit (355) an activation response to the first device 110 to indicate an active state of the ML entity 130. The first device 110 may receive (360) the activation response from the second device 120. For example, the activation request may be a ProvMnS request to activate the MLApp1. The ProvMnS request may include an APP-ID of the MLApp1. Accordingly, the activation response may be a ProvMnS response indicating that service has been activated.

Additionally, in some example embodiments, the first device 110 may transmit (365), to a third device 301, a first registration request to store the first mapping for the ML entity 130. After receiving (370) the first registration request, the third device 301 stores (375) the first mapping in association with an identification of the ML entity 130. For example, the first registration request may request the third device 130 to store F_{actual2as} and Fₐₛ₂ₐₐ for the MLApp1. The first registration request may include the APP ID of the MLApp1. Accordingly, the third device 130 may store F_{actual2as} and Fₐₛ₂ₐₐ in association with the APP ID.

### Example Mapping Update Procedure for ML Abstract Behavior Management

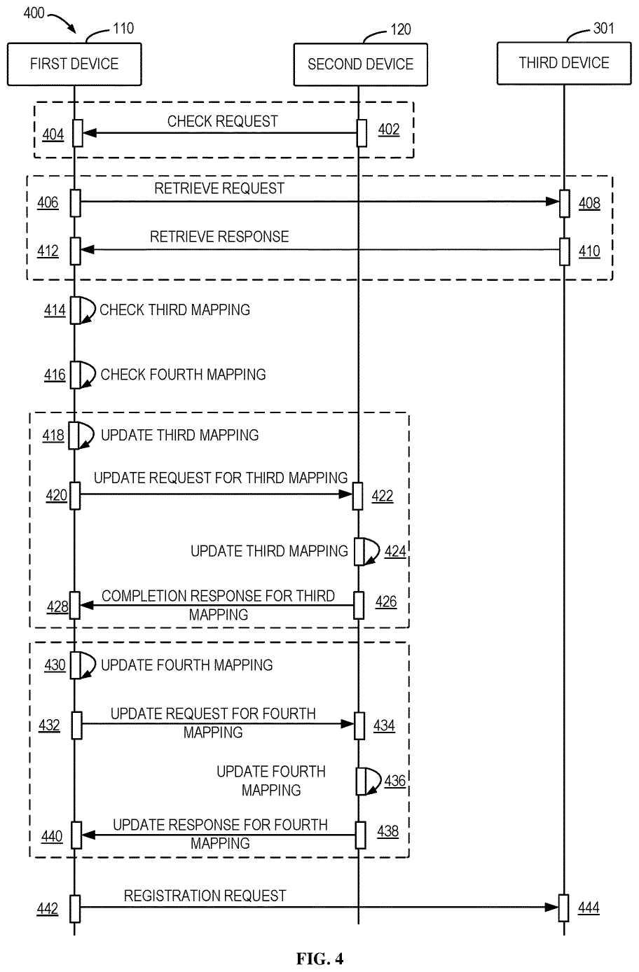

Whenever needed, a check and update of the first mapping can be done. The check and update may be triggered by the second device 120, e.g., when it detects conflict(s) between the first and second abstract actions. The check and update may be triggered by the first device 110, e.g., when it notices the unexpected behaviors of the ML entity 130. The example procedure for check and update of the first mapping is be discussed with respect to FIG. 4.

FIG. 4 illustrates a still further example signaling diagram of a ML abstract behavior management procedure 400 according to some example embodiments of the present disclosure. For the purposes of discussion, the procedure 400 will be discussed with reference to the first device 110 and the second device 120 of FIG. 1, as well as a third device 301 which may be, for example, a repository. In some example embodiments, the third device 301 may be implemented as a repository function at a core network or a function at OAM to register the profile/metadata of the MLApp instance. As an example, the procedure 400 may be a procedure to review and update the abstraction mappings for an MLApp instance, such as MLApp1.

In some example embodiments, the check and update of the first mapping may be triggered by the second device 120, for example, by the ML entity 130 or the MnS producer. In such example embodiments, as shown in FIG. 4, the second device 120 may transmit (402), to the first device 110, a check request to check the first mapping for the ML entity 130. If the difference between the first and second abstract actions is monitored, the second device 120 may transmit the check request. For example, the check request may include the APP ID of the MLApp1 and F_{actual2as} and Fₐₛ₂ₐₐ for the MLApp1. The first device 110 may receive (404) the check request from the second device 120.

Alternatively, in some example embodiments, the check and update of the first mapping may be triggered by the first device 110, for example, by the MnS consumer. For example, if the difference between the first and second abstract actions is monitored, the first device 110 may trigger the check and update of the first mapping. In such example embodiments, the first device 110 may transmit (406), to the third device 301, a retrieve request to retrieve the first mapping for the ML entity 130. In response to receiving (408) the retrieve request, the third device 301 may transmit (410), to the first device 110, a retrieve response indicating the first mapping for the ML entity 130. For example, the retrieve request may be a request for a current version of the abstraction mappings for the MLApp1. The retrieve request may be a response which includes the current F_{actual2as} and Fₐₛ₂ₐₐ for the MLApp1.

In response to the trigger, the first device 110 may update the first mapping by checking at least a portion of the first mapping. Then, the first device 110 may transmit, to the second device 120, an update request indicating the update to the first mapping. The second device 120 may update the first mapping accordingly and may transmit, to the first device 110, an update response indicating completion of the update to the first mapping.

The first mapping may comprises the third mapping (such as F_{actual2as}) and the fourth mapping (such as Fₐₛ₂ₐₐ), as mentioned above. In some example embodiments, the first device 110 may check (414) the third mapping. The first device 110 may update (418) the third mapping and transmit (420) an update request indicating the update to the third mapping to the second device 120. After receiving (422) the update request from the first device 110, the second device 120 may update (424) the third mapping locally. Then, the second device 120 may transmit (426) an update response for the third mapping to the first device 110 to indicate the third mapping has already been updated. Accordingly, the first device 110 may receive (428) the update response from the second device 120. For example, the mapping function F_{actual2as} may be reviewed by the first device 110 and at least a portion of F_{actual2as} may be updated by the first device 110. A ProvMns request acting as the update request may include the updated F_{actual2as} and the APP ID of the MLApp1. The second device 120 may update the mapping function F_{actual2as} locally and transmit a ProvMns response to the first device 110.

Alternatively, or in addition, the first device 110 may check (416) the fourth mapping. After checking (416) the fourth mapping, the first device 110 may update (430) the fourth mapping and transmit (432) an update request for the fourth mapping to the second device 120. After receiving (434) the update request from the first device 110, the second device 120 may update (436) the fourth mapping locally. Then, the second device 120 may transmit (426) an update response for the fourth mapping to the first device 110 to indicate that the fourth mapping has already been updated. The first device 110 may receive (440) the update response from the second device 120. For example, the mapping function Fₐₛ₂ₐₐ may be reviewed by the first device 110 and mapping relations for one or more abstract states may be updated by the first device 110. A ProvMns request acting as the update request may include IDs of the one or more abstract states and the updated mapping relations for the one or more abstract states. The second device 120 may update mapping relations for the one or more abstract states locally and transmit a ProvMns response to the first device 110.

In addition, in some example embodiments, the first device 110 may transmit (442), to the third device 301, a registration request to store the updated first mapping for the ML entity 130. In response to receiving (444) the registration request, the third device 301 may store the updated first mapping in association with the identification of the ML entity 130. For example, the registration request may include the APP ID of the MLApp1 and the current version of F_{actual2as} and Fₐₛ₂ₐₐ for the MLApp1.

### Example Retaining Procedure for ML Abstract Behavior Management

In example embodiments of the present disclosure, the ML entity 130 may be retrained with various ways. FIG. 5 shows an example retraining procedure 500 according to some example embodiments of the present disclosure. For the purposes of discussion, the procedure 500 will be discussed with reference to, for example, the first device 110 and the second device 120 of FIG. 1, as well as a fourth device 501 related to machine learning training or model training.

If needed, the first device 110 or the second device 120 may trigger the retraining of the ML entity 130. In some example embodiments, the retraining may be triggered by the second device 120. In such example embodiments, as shown in FIG. 5, the second device 120 may transmit (502), to the first device 110, a training request to train the ML entity 130. The first device 110 may receive (504) the training request from the second device 120 and perform the training procedure. When triggering the retraining, the second device 120 may also provide the reason in the training request. For example, the training request may include a reason indication of “mapping update,” “too many conflicts”, or the like.

In some example embodiments, the retraining involves the fourth device 401. As shown in FIG. 5, the first device 110 may transmit (506) a first message to the fourth device 501 to initiate training of the ML entity 130 based on the updated first mapping. The fourth device 501 may receive (508) the first message and determines whether the training of the ML entity 130 is completed. Then, the fourth device 501 may transmit (510) a second message indicating a trained instance of the ML entity 130 to the first device 110. The first device 110 may receive (512) the second message from the fourth device 501 and obtains (514) the trained instance of the ML entity 130 from the second message.

In some example embodiments, the fourth device 501 may comprise an ML training function. In this case, the first device 110 may transmit (506) a machine learning model training request to the fourth device 501. The fourth device 501 may then transmit (510) a machine learning model training report to the first device 110 to indicate the trained instance of the ML entity 130.

Alternatively, in some example embodiments, the fourth device 501 may comprise a network data analytics function (NWDAF) with a model training logical function (MTLF). In this case, the first device 110 may transmit (506) a subscription request for machine learning model provision to the fourth device 501. The fourth device 501 may then transmit (510) a notification of machine learning model information to the first device 110 to indicate the trained instance of the ML entity 130.

With the knowledge of the trained instance of the ML entity 130, the first device 110 may transmit (516) an update request to the second device 120 to update a current instance of the ML entity 130 to the trained instance. The second device 120 may receive (518) the updated request from the first device 110 and update the ML entity 130 based on the received update request. Then, the second device 120 may transmit (520), to the first device 110, an update response indicating completion of the update of the ML entity 130. The first device 110, upon receiving (522) the update response from the second device 120, may be aware of the completion of the update of the ML entity 130.

As an alternative, in some example embodiments, the ML entity 130 may be trained by the second device 120 directly. The second device 120 may transmit (524) a notification of training to the first device 110. The first device 110, upon receiving (526) the notification, may know that the ML entity 130 is trained by the second device 120.

In some example embodiments, the first device 110 may transmit (528) an activation request to the second device 120 to activate the retrained ML entity 130. The second device 120, upon receiving (530) of the activation request, may transmit (532) an activation response to the first device 110 to indicate an active state of the retrained ML entity 130. The first device 110 may receive (534) the activation response from the second device 120. For example, the activation request may be a ProvMnS request to activate the retrained MLApp1. The ProvMnS request may include an APP-ID of the retrained MLApp1. Accordingly, the activation response may be a ProvMnS response indicating that service has been activated.

The example procedure 500 is described. Reference is now made back to steps 506-522. As mentioned above, in some example embodiments, the fourth device 401 may comprise the ML training function, such as an AIML training function. In such example embodiments, the ML entity 130 (its ML model or the solution as a whole) may be trained by the ML training function. The first device 110 may transmit (506) to the second device 120 an AIML training request to request a new training with mapping function as training context. This request may include or indicate an AIML entity ID (for example, the APP ID of the MLApp1), APP construct, a candidate training data resource and expected runtime context. The training context may be manually defined, or learned from a separate analytics function. This request may further comprise the updated first mapping, for example, F_{actual2as} and Fₐₛ₂ₐₐ. For example, the attribute “expectedRuntimeContext” in AIMLTrainingRequest may be extended to carry the updated mapping function(s), such as F_{actual2as} and Fₐₛ₂ₐₐ. The mapping function as (part of) expectedRuntimeContext may be used in inference for non-Reinforcement learning.

Once the second device 120 decides to start the training as per the training request, the second device 120 may instantiate one or more training processes that are responsible to perform the training procedures, including training data collecting, preparing and selecting the training data, actual training. For example, one or more AIMLTrainingProcess MOI(s) may be instantiated. After the training completed, the second device 120 may transmit (510) an AIML training report with a new ID of the ML entity 130 to the first device 110. For example, the AIMLTrainingReport may be transmitted with a new AIMLEntityID. Further, at steps 514 to 522, the first device 110 may provide the updated instance of the ML entity to the second device 120 and get feedback from the second device 120.

As an alternative, in some example embodiments, the fourth device 401 may comprise the NWDAF with the MTLF. In such example embodiments, the ML entity 1300 (its ML model or the solution as a whole) may be trained by the NWDAF with the MTLF. The first device 110 may transmit (506) to the second device 120 Nnwdaf_MLModelProvision_Subscribe including Analytics ID, and further parameters. As such, the first device 110 subscribes to the MTLF in order to get the trained ML entity associated with Analytics ID. Such subscription is issued as a result of the second device 120 acting as any NF and requesting an analytics results for specific Analytics ID, or if the first device 110 is mapped to AnLF it can request model provisioning from MTLF directly. The subscription may be extended to carry the updated mapping function(s) (such as F_{actual2as} and Fₐₛ₂ₐₐ), which indicates that retraining is needed as already signalled by the second device 120.

After receiving (508) the subscription, the MTLF may determine whether triggering retraining for an existing trained ML model/solution is needed. However, based on the extension in the subscription, the indication of whether trigger retraining will be already part of the subscription in the manner: if the MTLF detects the mappings in the subscription are different from the earlier ones, the MTLF can directly start with retraining.

At 510, the MTLF may invoke the Nnwdaf_MLModelProvision_Notify service operation to notify an available retrained ML model/solution when the NWDAF with the MTLF determines that the previously provided trained ML Model/solution required retraining and is already re-trained. Such procedure is leveraged in this step such that MTLF can notify the first device 110 about re-trained MLApp instance.

Further, at steps 514 to 522, the first device 110 may provide the updated instance of the ML entity to the second device 120 and get feedback from the second device 120.

It is to be noted that in the FIG. 5, the first device 110 (such as AI/ML MnS Consumer) is mapped to AnLF and may communicate to the MTLF directly. Alternatively, the first device 110 (such as AI/ML MnS Consumer) may be mapped to an NF (or OAM) which may request certain analytics from AnLF. The AnLF consequently may request the MTLF for model training/re-training.

### Example Information Model Definitions for ML Abstract Behavior Management

The following example embodiments of the present disclosure will discuss information object classes (IOCs) and data types needed to realize ML Transfer learning as well as the relationships among these IOCs and data types.

FIG. 6A illustrates an example diagram of an information model for abstract behavior when exhibited by the AI/ML function according to some example embodiments of the present disclosure. As shown in FIG. 6A, there are 4 classes, namely, ManagedEntity 601, AI/MLFunction 602, MLEntity 603 and abstractBehavior 604, where abstract behaviors 604 are exhibited by the AI/ML Function 602. The relationships among these classes are shown in the class diagram of FIG. 6A.

FIG. 6B illustrates an example diagram of an information model for abstract behavior when exhibited by the MLEntity according to some example embodiments of the present disclosure. In these embodiments, abstract behaviors 604 are exhibited by the MLEntity 603 and relationships among classes ManagedEntity 601, AI/MLFunction 602, MLEntity 603 and abstractBehavior 604 are shown the class diagram of FIG. 6B.

FIG. 6C illustrates an example diagram of inheritance relations for abstract behavior according to some example embodiments of the present disclosure. Specifically, relationships among classes AI/MLFunction 602, MLEntity 603 and abstractBehavior 604, Top 605 and Function 606 are shown in the class diagram of FIG. 6C.

Some example embodiments related to class definitions are discussed below. Specifically, properties and attributes of the classes are defined as follows.
AI/MLFunction <<IOC>>

AI/MLFunction <<IOC>> represents properties of an AI/MLFunction. Each AI/MLFunction 602 is a managed object instantiable from the AI/MLFunction information object class and name-contained in either a Subnetwork, a ManagedFunction or a ManagementFunction. The AI/MLFunction 602 is a type of managed Function, i.e. the AI/MLFunction 602 is a subclass of and inherits the capabilities of a managed Function.

Each AI/MLFunction 602 shall be associated with one or more MLEntities.

Each AI/MLFunction 602 may be associated in fact shall have a candidate AbstractBehavior.

Each AI/MLFunction 602 may be associated, in fact shall have, one or more instances of AbstractBehavior which is a pair of lists respectively containing the candidate and the selected state-action pairs.

An instance of AbstractBehavior at the AI/MLFunction 602 may also be associated with a specific MLEntity.

The abstractBehavior is conditionally mandatory with the condition that it must be associated with the AI/MLFunction if it is not associated with the mLEntity that itself is associated with the AI/MLFunction.

The AI/MLFunction IOC includes the following attributes shown in Table 4.

TABLE 4

| | Support | isRead- | isWrit- | isIn- | isNoti- |
|---|---|---|---|---|---|
| Attribute name | Qualifier | able | able | variant | fyable |
| aIMLFunctionId | CM | T | F | F | F |
| mLEntity | CM | T | F | F | F |
| abstractBehavior | CM | T | F | F | F |

MLEntity <<IOC>>

This IOC represents the properties of an MLEntity 603. Each MLEntity 603 is a managed object contained on or associated with an AI/MLFunction 602.

Each MLEntity 603 may be associated, in fact shall have, an instance of AbstractBehavior, which is a pair of lists respectively containing the candidate and the selected state-action pairs.

The abstractBehavior is conditionally mandatory with the condition that it must be associated with the MLEntity 603 if it is not associated with the AI/MLFunction 602 for which the MLEntity 603 computes outcomes.

The MLEntity IOC includes the following attributes shown in Table 5.

TABLE 5

| | Support | isRead- | isWrit- | isIn- | isNoti- |
|---|---|---|---|---|---|
| Attribute name | Qualifier | able | able | variant | fyable |
| mLEntityId | CM | T | F | F | F |
| abstractBehavior | CM | T | F | F | F |

abstractBehavior <<IOC>>

This IOC represents the properties of abstractBehavior.

The abstractBehavior is associated to either an MLEntity or an AI/MLFunction. The abstract behavior contains characteristics of the abstract behavior of the MLEntity or ML function.

The abstract behavior contains 2 lists, a list of candidate abstract states and their candidate actions and a list of the selected and configured abstract states and their respective selected actions.

The MLKnowledgeRequest IOC includes the following attributes in Table 6.

TABLE 6

| | Support | isRead- | isWrit- | isIn- | isNoti- |
|---|---|---|---|---|---|
| Attribute name | Qualifier | able | able | variant | fyable |
| candidate- | M | T | F | F | F |
| AbstractStates | | | | | |
| applied- | M | T | F | F | F |
| AbstractStates | | | | | |

candidateAbstractState <<datatype>>

This dataType represents the properties of abstractState. The candidateAbstractState is a list of abstract states and where each state has a list of candidate abstract actions for that abstract state.

Each abstractState, may be identified with an identifier. The abstractState may be characterized by a human readable description which enables the human MnS consumers to know what features are grouped within that abstract state.

Each abstractState may have at least 2 possible actions that may be taken within that state. These are listed in the possibleActions attribute on the abstractState. The possibleActions are an enumeration of possible actions from which the MnS consumers can pick one that should be applied.

The abstractState <<datatype>> includes the following attributes in Table 7.

TABLE 7

| | Support | isRead- | isWrit- | isIn- | isNoti- |
|---|---|---|---|---|---|
| Attribute name | Qualifier | able | able | variant | fyable |
| abstractStateId | M | T | F | F | F |
| Description | O | T | F | F | F |
| possibleActions | M | T | F | F | F |

appliedAbstractState <<datatype>>

This dataType represents the properties of appliedAbstractState. The appliedAbstractStates is a list of state-action tuples.

Each appliedAbstractState has 1 action that has been selected either by the MnS producer or by an MnS consumer to be applied.

Each state may be represented by an identifier for the respective state as listed in the candidateAbstractStates.

Similarly, each action may be represented by an identifier for the respective action as listed in the candidate AbstractBehavior.

The abstractState <<datatype>> includes the following attributes in Table 8.

TABLE 8

| | Support | isRead- | isWrit- | isIn- | isNoti- |
|---|---|---|---|---|---|
| Attribute name | Qualifier | able | able | variant | fyable |
| abstractStateId | M | T | F | F | F |
| action | M | T | F | F | F |

### Example Methods

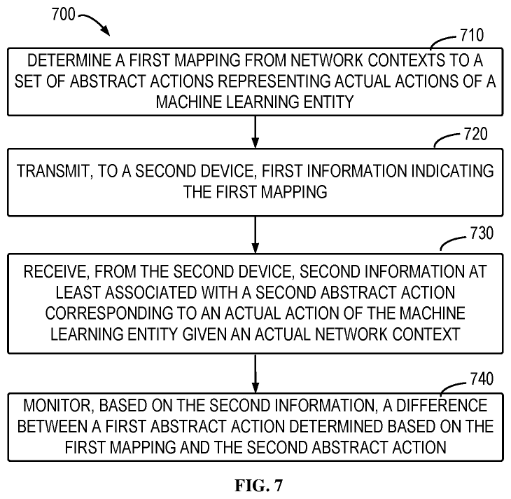

FIG. 7 shows a flowchart of an example method 700 implemented at a first device in accordance with some example embodiments of the present disclosure. For the purpose of discussion, the method 700 will be described from the perspective of the first device 110 in FIG. 1.

At block 710, the first device 110 determines a first mapping from network contexts to a set of abstract actions representing actual actions of a machine learning entity.

At block 720, the first device 110 transmits, to a second device, first information indicating the first mapping.

At block 730, the first device 110 receives, from the second device, second information at least associated with a second abstract action corresponding to an actual action of the machine learning entity given an actual network context.

At block 740, the first device 110 monitors, based on the second information, a difference between a first abstract action determined based on the first mapping and the second abstract action.

In some example embodiments, the first mapping comprises: a third mapping from the network contexts to a first set of abstract states representing actual states associated with the machine learning entity, and a fourth mapping from the first set of abstract states to the set of abstract actions.

In some example embodiments, the first set of abstract states is a subset of a second set of abstract states representing the actual states, and a given abstract state in the second set is associated with at least one of: an identifier of the given abstract state, a description of the abstract state, and at least one abstract action available in the abstract state.

In some example embodiments, the first and second sets of abstract states are comprised in an abstract behavior associated with at least one of: the machine learning entity, or a function associated with the machine learning entity.

In some example embodiments, the method 700 further comprises: receiving, from the second device, an instantiation response indicating completion of the instantiation of the machine learning entity.

In some example embodiments, the method further comprises: transmitting, to a third device, a first registration request to store the first mapping for the machine learning entity.

In some example embodiments, the method 700 further comprises: updating the first mapping by checking at least a portion of the first mapping; transmitting, to the second device, a first update request indicating the update to the first mapping; and receiving, from the second device, a first update response indicating completion of the update to the first mapping.

In some example embodiments, updating the first mapping comprises updating at least one of: a mapping from a network context to an abstract state in a first set of abstract states representing actual states associated with the machine learning entity, or a mapping from an abstract state in the first set of abstract states to one or more abstract actions in the set of abstract actions.

In some example embodiments, the method 700 further comprises: receiving, from the second device, a check request to check the first mapping for the machine learning entity.

In some example embodiments, the method 700 further comprises: in response to that the difference is monitored, transmitting, to a third device, a retrieve request to retrieve the first mapping for the machine learning entity; and receiving, from the third device, a retrieve response indicating the first mapping for the machine learning entity.

In some example embodiments, the method further comprises: transmitting, to the third device, a second registration request to store the updated first mapping for the machine learning entity.

In some example embodiments, the method 700 further comprises: transmitting, to a fourth device, a first message to initiate training of the machine learning entity based on the updated first mapping; receiving, from the fourth device, a second message indicating a trained instance of the machine learning entity; transmitting, to the second device, a second update request to update a current instance of the machine learning entity to the trained instance; and receiving, from the second device, a second update response indicating completion of the update of the machine learning entity.

In some example embodiments, the method 700 further comprises: receiving, from the second device, a request to train the machine learning entity.

In some example embodiments, the fourth device comprises a machine learning training function, the first message comprises a machine learning model training request, and the second message comprises a machine learning model training report.

In some example embodiments, the fourth device comprises a network data analytics function with a model training logical function, the first message comprises a subscription request for machine learning model provision, and the second message comprises a notification of machine learning model information.

In some example embodiments, the second information comprises at least one of: indications of the first and second abstract actions, an indication of the second abstract action, or an indication of whether the difference between the first and second abstract actions exists.

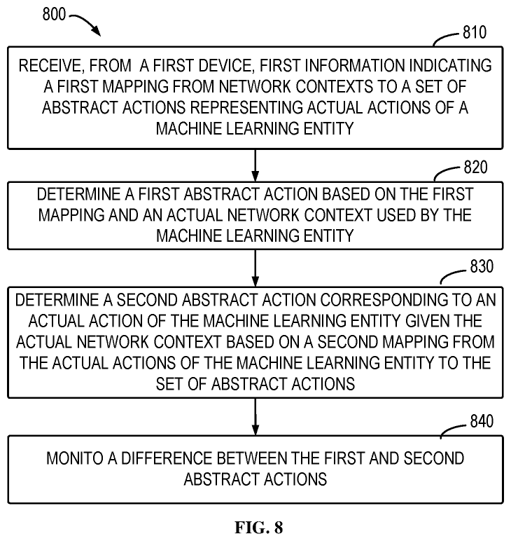

FIG. 8 shows a flowchart of an example method 800 implemented at a second device in accordance with some example embodiments of the present disclosure. For the purpose of discussion, the method 800 will be described from the perspective of the second device 120 in FIG. 1.

At block 810, the second device 120 receives, from a first device 110, first information indicating a first mapping from network contexts to a set of abstract actions representing actual actions of a machine learning entity.

At block 820, the second device 120 determines a first abstract action based on the first mapping and an actual network context used by the machine learning entity.

At block 830, the second device 120 determines a second abstract action corresponding to an actual action of the machine learning entity given the actual network context based on a second mapping from the actual actions of the machine learning entity to the set of abstract actions.

At block 840, the second device 120 monitors a difference between the first and second abstract actions.

At block 850, the second device 120 transmits, to the first device 110, second information at least associated with the second abstract action.

In some example embodiments, the first mapping comprises the following: a third mapping from the network contexts to a first set of abstract states representing actual states associated with the machine learning entity, and a fourth mapping from the first set of abstract states to the set of abstract actions.

In some example embodiments, the first set of abstract states is a subset of a second set of abstract states representing the actual states, and a given abstract state in the second set is associated with at least one of: an identifier of the given abstract state, a description of the abstract state, and at least one abstract action available in the abstract state.

In some example embodiments, the first and second sets of abstract states are comprised in an abstract behavior associated with at least one of: the machine learning entity, or a function associated with the machine learning entity.

In some example embodiments, the method further comprises: in response to the instantiation request, instantiating the machine learning entity with the first mapping; and transmitting, to the first device, an instantiation response indicating completion of the instantiation of the machine learning entity.

In some example embodiments, the method 800 further comprises: receiving, from the first device, a first update request indicating an update to the first mapping; updating the first mapping based on the first update request; and transmitting, to the first device, a first update response indicating completion of the update to the first mapping.

In some example embodiments, updating the first mapping comprises updating at least one of: a mapping from a network context to an abstract state in a first set of abstract states representing actual states associated with the machine learning entity, or a mapping from an abstract state in the first set of abstract states to one or more abstract actions in the set of abstract actions.

In some example embodiments, the method 800 further comprises: in response to that the difference is monitored, transmitting, to the first device, a check request to check the first mapping for the machine learning entity.

In some example embodiments, the method 800 further comprises: receiving, from the first device, a second update request to update a current instance of the machine learning entity to a trained instance of the machine learning entity, the trained instance being trained based on the updated first mapping; updating the machine learning entity based on the second update request; and transmitting, to the first device, a second update response indicating completion of the update of the machine learning entity.

In some example embodiments, the method 800 further comprises: transmitting, to the first device, a request to train the machine learning entity.

In some example embodiments, the second information comprises at least one of: an indication of the first abstract action and an indication of the second abstract action, an indication of the second abstract action, or an indication of whether the difference between the first and second abstract actions exists.

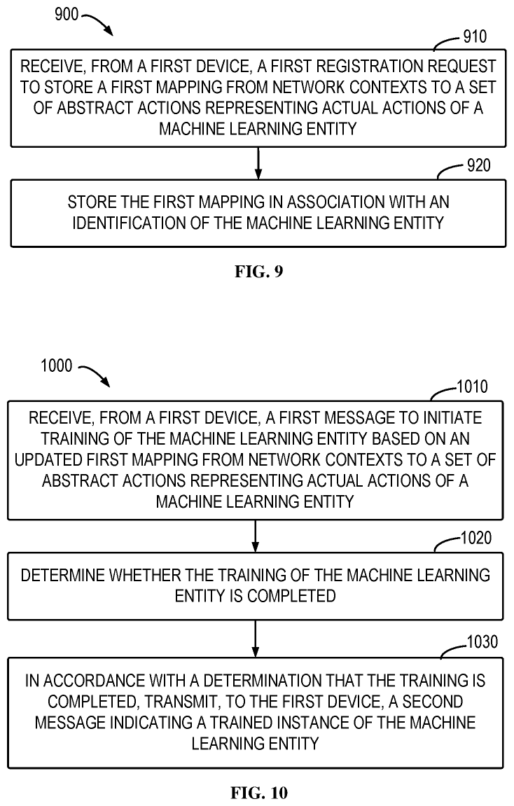

FIG. 9 shows a flowchart of an example method 900 implemented at a third device in accordance with some example embodiments of the present disclosure. For the purpose of discussion, the method 900 will be described from the perspective of the third device 301.

At block 910, the third device 301 receives, from a first device 110, a first registration request to store a first mapping from network contexts to a set of abstract actions representing actual actions of a machine learning entity.

At block 920, the third device 301 stores the first mapping in association with an identification of the machine learning entity.

In some example embodiments, the first mapping comprises: a third mapping from the network contexts to a first set of abstract states representing actual states associated with the machine learning entity, and a fourth mapping from the first set of abstract states to the set of abstract actions.

In some example embodiments, the method 900 further comprises: receiving, from the first device, a retrieve request to retrieve the first mapping for the machine learning entity; and transmitting, to the first device, a retrieve response indicating the first mapping for the machine learning entity.

In some example embodiments, the method 900 further comprises: receiving, from the first device, a second registration request to store the updated first mapping for the machine learning entity; and storing the updated first mapping in association with the identification of the machine learning entity.

FIG. 10 shows a flowchart of an example method 1000 implemented at a fourth device in accordance with some example embodiments of the present disclosure. For the purpose of discussion, the method 1000 will be described from the perspective of the fourth device 501.

At block 1010, the fourth device 501 receives, from a first device 110, a first message to initiate training of the machine learning entity based on an updated first mapping from network contexts to a set of abstract actions representing actual actions of a machine learning entity.

At block 1020, the fourth device 501 determines whether the training of the machine learning entity is completed.

At block 1030, in accordance with a determination that the training is completed, the fourth device 501 transmits a second message to the first device 110. The second message indicates a trained instance of the machine learning entity.

In some example embodiments, the fourth device 501 comprises a machine learning training function, the first message comprises a machine learning model training request, and the second message comprises a machine learning model training report.

In some example embodiments, the fourth device 501 comprises a network data analytics function with a model training logical function, the first message comprises a subscription request for machine learning model provision, and the second message comprises a notification of machine learning model information.

### Example Apparatus, Device and Medium

In some example embodiments, a first apparatus capable of performing any of the method 700 (for example, the first device 110 in FIG. 1) may comprise means for performing the respective operations of the method 700. The means may be implemented in any suitable form. For example, the means may be implemented in a circuitry or software module. The first apparatus may be implemented as or included in the first device 110 in FIG. 1.

In some example embodiments, the first apparatus comprises means for determining a first mapping from network contexts to a set of abstract actions representing actual actions of a machine learning entity; means for transmitting, to a second device, first information indicating the first mapping; means for receiving, from the second device, second information at least associated with a second abstract action corresponding to an actual action of the machine learning entity given an actual network context; and means for monitoring, based on the second information, a difference between a first abstract action determined based on the first mapping and the second abstract action.

In some example embodiments, the first mapping comprises: a third mapping from the network contexts to a first set of abstract states representing actual states associated with the machine learning entity, and a fourth mapping from the first set of abstract states to the set of abstract actions.

In some example embodiments, the first set of abstract states is a subset of a second set of abstract states representing the actual states, and a given abstract state in the second set is associated with at least one of: an identifier of the given abstract state, a description of the abstract state, and at least one abstract action available in the abstract state.

In some example embodiments, the first and second sets of abstract states are comprised in an abstract behavior associated with at least one of: the machine learning entity, or a function associated with the machine learning entity.

In some example embodiments, the first apparatus may further comprise: means for receiving, from the second device, an instantiation response indicating completion of the instantiation of the machine learning entity.

In some example embodiments, the first apparatus may further comprise: means for transmitting, to a third device, a first registration request to store the first mapping for the machine learning entity.

In some example embodiments, the first apparatus may further comprise: means for updating the first mapping by checking at least a portion of the first mapping; means for transmitting, to the second device, a first update request indicating the update to the first mapping; and means for receiving, from the second device, a first update response indicating completion of the update to the first mapping.

In some example embodiments, means for updating the first mapping comprises means for updating at least one of: a mapping from a network context to an abstract state in a first set of abstract states representing actual states associated with the machine learning entity, or a mapping from an abstract state in the first set of abstract states to one or more abstract actions in the set of abstract actions.

In some example embodiments, the first apparatus may further comprise: means for receiving, from the second device, a check request to check the first mapping for the machine learning entity.

In some example embodiments, the first apparatus may further comprise: means for in response to that the difference is monitored, transmitting, to a third device, a retrieve request to retrieve the first mapping for the machine learning entity; and means for receiving, from the third device, a retrieve response indicating the first mapping for the machine learning entity.

In some example embodiments, the first apparatus may further comprise: means for transmitting, to the third device, a second registration request to store the updated first mapping for the machine learning entity.

In some example embodiments, the first apparatus may further comprise: means for transmitting, to a fourth device, a first message to initiate training of the machine learning entity based on the updated first mapping; means for receiving, from the fourth device, a second message indicating a trained instance of the machine learning entity; means for transmitting, to the second device, a second update request to update a current instance of the machine learning entity to the trained instance; and means for receiving, from the second device, a second update response indicating completion of the update of the machine learning entity.

In some example embodiments, the first apparatus may further comprise: means for receiving, from the second device, a request to train the machine learning entity.

In some example embodiments, the fourth device comprises a machine learning training function, the first message comprises a machine learning model training request, and the second message comprises a machine learning model training report.

In some example embodiments, the fourth device comprises a network data analytics function with a model training logical function, the first message comprises a subscription request for machine learning model provision, and the second message comprises a notification of machine learning model information.

In some example embodiments, the second information comprises at least one of: indications of the first and second abstract actions, an indication of the second abstract action, or an indication of whether the difference between the first and second abstract actions exists.

In some example embodiments, the first apparatus further comprises means for performing other operations in some example embodiments of the method 700 or the first device 110. In some example embodiments, the means comprises at least one processor; and at least one memory storing instructions that, when executed by the at least one processor, cause the performance of the first apparatus.

In some example embodiments, a second apparatus capable of performing any of the method 800 (for example, the second device 120 in FIG. 1) may comprise means for performing the respective operations of the method 800. The means may be implemented in any suitable form. For example, the means may be implemented in a circuitry or software module. The second apparatus may be implemented as or included in the second device 120 in FIG. 1.

In some example embodiments, the second apparatus comprises means for receiving, from a first device, first information indicating a first mapping from network contexts to a set of abstract actions representing actual actions of a machine learning entity; means for determining a first abstract action based on the first mapping and an actual network context used by the machine learning entity; means for determining a second abstract action corresponding to an actual action of the machine learning entity given the actual network context based on a second mapping from the actual actions of the machine learning entity to the set of abstract actions; and means for monitoring a difference between the first and second abstract actions; and means for transmitting, to the first device, second information at least associated with the second abstract action.

In some example embodiments, the first mapping comprises the following: a third mapping from the network contexts to a first set of abstract states representing actual states associated with the machine learning entity, and a fourth mapping from the first set of abstract states to the set of abstract actions.

In some example embodiments, the first set of abstract states is a subset of a second set of abstract states representing the actual states, and a given abstract state in the second set is associated with at least one of: an identifier of the given abstract state, a description of the abstract state, and at least one abstract action available in the abstract state.

In some example embodiments, the first and second sets of abstract states are comprised in an abstract behavior associated with at least one of: the machine learning entity, or a function associated with the machine learning entity.

In some example embodiments, the second apparatus may further comprise: means for in response to the instantiation request, instantiating the machine learning entity with the first mapping; and means for transmitting, to the first device, an instantiation response indicating completion of the instantiation of the machine learning entity.

In some example embodiments, the second apparatus may further comprise: means for receiving, from the first device, a first update request indicating an update to the first mapping; means for updating the first mapping based on the first update request; and means for transmitting, to the first device, a first update response indicating completion of the update to the first mapping.

In some example embodiments, means for updating the first mapping comprises means for updating at least one of: a mapping from a network context to an abstract state in a first set of abstract states representing actual states associated with the machine learning entity, or a mapping from an abstract state in the first set of abstract states to one or more abstract actions in the set of abstract actions.

In some example embodiments, the second apparatus may further comprise: means for in response to that the difference is monitored, transmitting, to the first device, a check request to check the first mapping for the machine learning entity.

In some example embodiments, the second apparatus may further comprise: means for receiving, from the first device, a second update request to update a current instance of the machine learning entity to a trained instance of the machine learning entity, the trained instance being trained based on the updated first mapping; means for updating the machine learning entity based on the second update request; and means for transmitting, to the first device, a second update response indicating completion of the update of the machine learning entity.

In some example embodiments, the second apparatus may further comprise: means for transmitting, to the first device, a request to train the machine learning entity.

In some example embodiments, the second information comprises at least one of: an indication of the first abstract action and an indication of the second abstract action, an indication of the second abstract action, or an indication of whether the difference between the first and second abstract actions exists.

In some example embodiments, the second apparatus further comprises means for performing other operations in some example embodiments of the method 800 or the second device 120. In some example embodiments, the means comprises at least one processor; and at least one memory storing instructions that, when executed by the at least one processor, cause the performance of the second apparatus.

In some example embodiments, a third apparatus capable of performing any of the method 900 (for example, the third device 301) may comprise means for performing the respective operations of the method 900. The means may be implemented in any suitable form. For example, the means may be implemented in a circuitry or software module. The third apparatus may be implemented as or included in the third device 301.

In some example embodiments, the third apparatus comprises means for receiving, from a first device, a first registration request to store a first mapping from network contexts to a set of abstract actions representing actual actions of a machine learning entity; and means for storing the first mapping in association with an identification of the machine learning entity.

In some example embodiments, the first mapping comprises: a third mapping from the network contexts to a first set of abstract states representing actual states associated with the machine learning entity, and a fourth mapping from the first set of abstract states to the set of abstract actions.

In some example embodiments, the third apparatus may further comprise: means for receiving, from the first device, a retrieve request to retrieve the first mapping for the machine learning entity; and means for transmitting, to the first device, a retrieve response indicating the first mapping for the machine learning entity.

In some example embodiments, the third apparatus may further comprise: means for receiving, from the first device, a second registration request to store the updated first mapping for the machine learning entity; and means for storing the updated first mapping in association with the identification of the machine learning entity.

In some example embodiments, the third apparatus further comprises means for performing other operations in some example embodiments of the method 900 or the third device 301. In some example embodiments, the means comprises at least one processor; and at least one memory storing instructions that, when executed by the at least one processor, cause the performance of the third apparatus.

In some example embodiments, a fourth apparatus capable of performing any of the method 1000 (for example, the fourth device 501) may comprise means for performing the respective operations of the method 1000. The means may be implemented in any suitable form. For example, the means may be implemented in a circuitry or software module. The fourth apparatus may be implemented as or included in the fourth device 501.

In some example embodiments, the fourth apparatus comprises means for receiving, from a first device, a first message to initiate training of the machine learning entity based on an updated first mapping from network contexts to a set of abstract actions representing actual actions of a machine learning entity; means for determining whether the training of the machine learning entity is completed; and means for in accordance with a determination that the training is completed, transmitting, to the first device, a second message indicating a trained instance of the machine learning entity.

In some example embodiments, the fourth device comprises a machine learning training function, the first message comprises a machine learning model training request, and the second message comprises a machine learning model training report.

In some example embodiments, the fourth device comprises a network data analytics function with a model training logical function, the first message comprises a subscription request for machine learning model provision, and the second message comprises a notification of machine learning model information.

In some example embodiments, the fourth apparatus further comprises means for performing other operations in some example embodiments of the method 1000 or the fourth device 501. In some example embodiments, the means comprises at least one processor; and at least one memory storing instructions that, when executed by the at least one processor, cause the performance of the fourth apparatus.

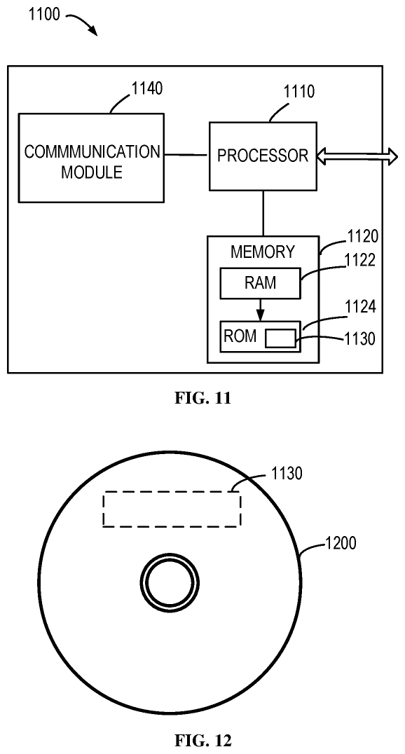

FIG. 11 is a simplified block diagram of a device 1100 that is suitable for implementing example embodiments of the present disclosure. The device 1100 may be provided to implement a communication device, for example, the first device 110 or the second device 120 as shown in FIG. 1. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has one or more communication interfaces to facilitate communication with one or more other modules or devices. The communication interfaces may represent any interface that is necessary for communication with other network elements. In some example embodiments, the communication module 1140 may include at least one antenna.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The instructions of the program 1130 may include instructions for performing operations/acts of some example embodiments of the present disclosure. The program 1130 may be stored in the memory, e.g., the ROM 1124.

The processor 1110 may perform any suitable actions and processing by loading the program 1130 into the RAM 1122.

The example embodiments of the present disclosure may be implemented by means of the program 1130 so that the device 1100 may perform any process of the disclosure as discussed with reference to FIG. 2 to FIG. 10. The example embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 12 shows an example of the computer readable medium 1200 which may be in form of CD, DVD or other optical storage disk. The computer readable medium 1200 has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory storing instructions that, when executed by the at least one processor, cause the first device at least to perform:
determining a first mapping from network contexts to a set of abstract actions representing actual actions of a machine learning entity;
transmitting, to a second device, first information indicating the first mapping;
receiving, from the second device, second information at least associated with a second abstract action corresponding to an actual action of the machine learning entity given an actual network context; and
monitoring, based on the second information, a difference between a first abstract action determined based on the first mapping and the second abstract action.

2. The first device of claim 1, wherein the first mapping comprises:
a third mapping from the network contexts to a first set of abstract states representing actual states associated with the machine learning entity, and
a fourth mapping from the first set of abstract states to the set of abstract actions.

3. The first device of claim 2, wherein the first set of abstract states is a subset of a second set of abstract states representing the actual states, and a given abstract state in the second set is associated with at least one of:
an identifier of the given abstract state,
a description of the abstract state, or
at least one abstract action available in the abstract state.

4. The first device of claim 3, wherein the first and second sets of abstract states are comprised in an abstract behavior associated with at least one of:
the machine learning entity, or
a function associated with the machine learning entity.

5. The first device of claim 1, wherein the first information indicating the first mapping is comprised in an instantiation request to instantiate the machine learning entity with the first mapping, and the first device is further caused to perform:
receiving, from the second device, an instantiation response indicating completion of the instantiation of the machine learning entity.

6. The first device of claim 1, wherein the first device is further caused to perform:
transmitting, to a third device, a first registration request to store the first mapping for the machine learning entity.

7. The first device of claim 1, wherein the first device is further caused to perform:
updating the first mapping by checking at least a portion of the first mapping;
transmitting, to the second device, a first update request indicating the update to the first mapping; and
receiving, from the second device, a first completion response indicating completion of the update to the first mapping.

8. The first device of claim 7, wherein updating the first mapping comprises updating at least one of:
a mapping from a network context to an abstract state in a first set of abstract states representing actual states associated with the machine learning entity, or
a mapping from an abstract state in the first set of abstract states to one or more abstract actions in the set of abstract actions.

9. The first device of claim 7, wherein the first device is further caused to perform:
receiving, from the second device, a check request to check the first mapping for the machine learning entity.

10. The first device of claim 7, wherein the first device is further caused to perform:
in response to that the difference is monitored, transmitting, to a third device, a retrieve request to retrieve the first mapping for the machine learning entity; and
receiving, from the third device, a retrieve response indicating the first mapping for the machine learning entity.

11. The first device of claim 10, wherein the first device is further caused to perform:
transmitting, to the third device, a second registration request to store the updated first mapping for the machine learning entity.

12. The first device of claim 7, wherein the first device is further caused to perform:
transmitting, to a fourth device, a first message to initiate training of the machine learning entity based on the updated first mapping;
receiving, from the fourth device, a second message indicating a trained instance of the machine learning entity;
transmitting, to the second device, a second update request to update a current instance of the machine learning entity to the trained instance; and
receiving, from the second device, a second completion response indicating completion of the update of the machine learning entity.

13-15. (canceled)

16. The first device of claim 1, wherein the second information comprises at least one of:
indications of the first and second abstract actions,
an indication of the second abstract action, or
an indication of whether the difference between the first and second abstract actions exists.

17. A second device comprising:
at least one processor; and
at least one memory storing instructions that, when executed by the at least one processor, cause the second device at least to perform:
receiving, from a first device, first information indicating a first mapping from network contexts to a set of abstract actions representing actual actions of a machine learning entity;
determining a first abstract action based on the first mapping and an actual network context used by the machine learning entity;
determining a second abstract action corresponding to an actual action of the machine learning entity given the actual network context based on a second mapping from the actual actions of the machine learning entity to the set of abstract actions;
monitoring a difference between the first and second abstract actions; and
transmitting, to the first device, second information at least associated with the second abstract action.

18. The second device of claim 17, wherein the first mapping comprises the following:
a third mapping from the network contexts to a first set of abstract states representing actual states associated with the machine learning entity, and
a fourth mapping from the first set of abstract states to the set of abstract actions.

19. The second device of claim 18, wherein the first set of abstract states is a subset of a second set of abstract states representing the actual states, and a given abstract state in the second set is associated with at least one of:
an identifier of the given abstract state,
a description of the abstract state, or
at least one abstract action available in the abstract state.

20. The second device of claim 19, wherein the first and second sets of abstract states are comprised in an abstract behavior associated with at least one of:
the machine learning entity, or
a function associated with the machine learning entity.

21. The second device of claim 17, wherein the first information indicating the first mapping is comprised in an instantiation request to instantiate the machine learning entity with the first mapping, and the second device is further caused to perform:
in response to the instantiation request, instantiating the machine learning entity with the first mapping; and
transmitting, to the first device, an instantiation response indicating completion of the instantiation of the machine learning entity.

22-27. (canceled)

28. A third device comprising:
at least one processor; and
at least one memory storing instructions that, when executed by the at least one processor, cause the third device at least to perform:
receiving, from a first device, a first registration request to store a first mapping from network contexts to a set of abstract actions representing actual actions of a machine learning entity; and
storing the first mapping in association with an identification of the machine learning entity.

29. The third device of claim 28, wherein the first mapping comprises:
a third mapping from the network contexts to a first set of abstract states representing actual states associated with the machine learning entity, and
a fourth mapping from the first set of abstract states to the set of abstract actions.

30-43. (canceled)
